(19) United States
(12) Patent Application Publication
(10) Pub. No.: US 2026/0316016 A1
(43) Pub. Date: Oct. 15, 2026

(54) AERATOR DEVICE FOR AERATING A LIQUID WITH NANOBUBBLES

(71) Applicant: University of Utah Research Foundation, Salt Lake City, UT (US)

(72) Inventor: Andy HONG, Salt Lake City, UT (US)

(21) Appl. No.: 19/100,385

(22) PCT Filed: Aug. 2, 2023
(86) PCT No.: PCT/US2023/071511

§ 371 Date: Jan. 31, 2025

Related U.S. Application Data
(60) Provisional application No. 63/394,446, filed on Aug. 2, 2022.

(51) Int. Cl. B01F 23/231; B01F 23/2326; B01F 23/2375; B01F 25/313; B01F 101/00; F16L 55/07

(52) U.S. Cl. CPC B01F 23/231233; B01F 23/2326; B01F 23/2375; B01F 25/313311; F16L 55/07; B01F 2101/305

(57) ABSTRACT

An aerator device (110) can be inserted into a liquid fluid flow (119) within a conduit (102) to aerate a liquid. The aerator device (110) includes an elongated rod (112) defining a flow path for a gaseous fluid separate from the liquid fluid flow (119). The elongated rod (112) can include a flow portion (114) defining the flow path to release the gaseous fluid into the liquid fluid flow (119). The elongated rod (112) can further include a tapered leading end (116) disposed upstream from the flow portion (114) within the liquid fluid flow (119). The aerator device (110) can include a hydrophobic membrane (118) in fluid communication with the flow portion (114) of the elongated rod (112) such that the gaseous fluid released from the flow portion (114) of the elongated rod (112) is released to the liquid fluid flow (119) through the hydrophobic membrane (118).

### CROSS REFERENCE TO RELATED APPLICATION

This application claims the benefit of U.S. Provisional Application Ser. No. 63/394,446, filed Aug. 2, 2022, and entitled, “Aerator Device For Aerating A Liquid With Nanobubbles,” which is incorporated by reference in its entirety herein.

### STATEMENT REGARDING FEDERALLY SPONSORED RESEARCH OR DEVELOPMENT

This invention was made with government support under grant R19AC00157 awarded by the United States Department of Interior Bureau of Reclamation. The government has certain rights in this invention.

### NAMES OF THE PARTIES TO A JOINT RESEARCH AGREEMENT

Not applicable.

### INCORPORATION BY REFERENCE STATEMENT

Not applicable.

### BACKGROUND

Aeration of liquids in environmental applications, such as aquaculture, has been shown to provide significant environmental benefits. Aeration techniques are commonly used in pond, lake, and reservoir management to address low oxygen levels in bodies of water. Aeration helps to increase or maintain oxygen saturation of liquid in both natural and artificial environments and has been shown to provide significant health improvements for both wildlife and vegetation, such as enhanced fish and plant growth when exposed to aerated liquid. Additionally, aeration in waste liquid treatment and disinfecting applications has been shown to intensify microbial growth, organic degradation, liquid disinfection, and chemical removal, thereby increasing the efficiency of waste liquid treatment processes without the need of additional oxygen. Additional applications and liquids shown to benefit from aeration include surface cleaning, froth flotation, ultrasound contrast agents, drug delivery, drag reduction, promotion of physiological activities in living organisms, sterilization of bacteria, enhancing seed germination rates, improving blood oxygenation, improving engine efficiency, and many others.

For the reasons stated above, devices and systems for aerating water and other liquids with bubbles (e.g., micro-bubbles and nano-bubbles) continue to be researched. However, current devices, systems, and methods for aerating liquids, particularly producing micro and nano-bubbles in liquids, are typically large, complex, expensive, and consume large amounts of energy and money during operation. Accordingly, a need exists in aeration applications for devices with less complexity, better efficiency, and less energy consumption than is currently available.

### SUMMARY

An initial summary of the disclosed technology is provided here. Specific technology examples are described in further detail below. This initial summary is intended to set forth examples and aid readers in understanding the technology more quickly but is not intended to identify key features or essential features of the technology, nor is it intended to limit the scope of the claimed subject matter.

In one example of the present disclosure, an aerator device is disclosed. The aerator device can be configured to be inserted into a liquid fluid flow within a conduit. The aerator can include an elongated rod defining a flow path configured to direct a flow of a gaseous fluid, the flow path being separate from the liquid fluid flow. The elongated rod can include a flow portion defining the flow path configured to carry the gaseous fluid and configured to release the gaseous fluid into the liquid fluid flow. The elongated rod can further include a leading end disposed upstream from the flow portion within the liquid fluid flow. The leading end can be exposed to the liquid fluid flow. The aerator device can further include a hydrophobic membrane in fluid communication with at least the flow portion of the elongated rod such that the gaseous fluid released from the flow portion of the elongated rod is released to the liquid fluid flow through the hydrophobic membrane.

In some examples, the leading end of the elongated rod can be tapered in shape, such that the tapered leading end starts at a point and expands to a perimeter of the elongated rod.

According to some examples, the elongated rod can further include a tapered trailing end. This can allow for streamlined liquid fluid flow and for incoming flow from either direction.

In some examples of the aerator device, the flow portion of the elongated rod can be a hollow tube defining the flow path for the gaseous fluid on an inside thereof.

In some examples of the aerator device, the flow portion, being the hollow tube, of the elongated rod can include one or more pores formed through an outer surface thereof to allow the gaseous fluid to pass from the flow path defined inside of the flow portion to an outside of the elongated rod and through the hydrophobic membrane.

In an additional example of the aerator device, the flow portion of the elongated rod can be a solid rod having one or more protrusions extending away from an outer surface of the solid rod to define the flow path between the outer surface of the solid rod and an inner surface of the hydrophobic membrane.

In some examples of the aerator device, the one or more protrusions can define a helical path around the outer surface of the flow portion, the helical being disposed between the outer surface of the solid rod and the inner surface of the hydrophobic membrane as the flow path.

In some examples of the aerator device, the one or more protrusions can include a plurality of separate protrusions spaced about the outer surface of the solid rod.

In some examples of the aerator device, the aerator device can be configured to aerate the liquid fluid flow with bubbles that are 200 micrometers or less.

In some examples of the aerator device, the aerator device can be configured to aerate the liquid fluid flow with bubbles that are 1 micrometer or less.

In some examples of the aerator device, the aerator device can be configured to aerate the liquid fluid flow with bubbles that are 200 nanometers or less.

In some examples of the aerator device, an outer surface of the flow portion where the gaseous fluid is configured to be released to the liquid fluid flow can be configured to be perpendicular to the liquid fluid flow within the conduit.

In some examples of the aerator device, the hydrophobic membrane can be made of one or more of polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, HDPE, or any combinations thereof. Hydrophobicity and ozone resistance are desirable characteristics for the hydrophobic membrane. As such, PTFE, FEP, PFA, ETFE, and PVDF are particularly useful as they have both high ozone resistance and hydrophobicity.

In some examples of the aerator device, the hydrophobic membrane can be made of a material having a hydrophobicity of a predetermined level or greater.

In some examples of the aerator device, the hydrophobic membrane can be made of a material having a contact angle of at least 90 degrees.

In some examples of the aerator device, the elongated rod can be made of one or more of stainless steel, titanium, HDPE, CPVC, PEX, Kynar, polycarbonate, fluoroelastomers (e.g. VITON), and ethylene acrylic elastomers (e.g. VAMAC), polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, and high density polyethylene (HDPE).

In short, the elongated rod can be made of any materials capable of structurally supporting the hydrophobic membrane in the conduit with liquid fluid flow. Also, if the hydrophobic membrane is sufficiently stiff, the elongated rod can be significantly shortened.

In one example of the present disclosure, an aerator system can include a conduit defining a fluid flow path for a liquid fluid flow, and an aerator device disposed within the conduit. The aerator device can include an elongated rod defining a flow path configured to direct a flow of a gaseous fluid, the flow path being separate from the liquid fluid flow. The elongated rod can include a flow portion defining the flow path configured to carry the gaseous fluid and configured to release the gaseous fluid into the liquid fluid flow. The elongated rod can further include a leading end disposed upstream from the flow portion within the liquid fluid flow and the leading end being exposed to the liquid fluid flow. The elongated rod can further include a hydrophobic membrane in fluid communication with at least the flow portion of the elongated rod such that the gaseous fluid released from the flow portion of the elongated rod is released to the liquid fluid flow through the hydrophobic membrane.

In some examples, the leading end of the elongated rod can be tapered in shape, such that the tapered leading end starts at a point and expands to a perimeter of the elongated rod.

In some examples, the elongated rod can further include a tapered trailing end. This can allow for streamlined liquid fluid flow and for incoming flow from either direction.

In some examples of the aerator system, the flow portion of the elongated rod can include a hollow tube defining the flow path for the gaseous fluid on an inside thereof.

In some examples of the aerator system, the flow portion, being the hollow tube, of the elongated rod can include one or more pores formed through an outer surface thereof to allow the gaseous fluid to pass from the flow path, through the one or more pores of the hollow tube, and through the hydrophobic membrane. In other words, the flow portion of the elongated rod is porous to allow the gaseous fluid to pass from the flow path defined inside of the flow portion to an outside of the elongated rod and through the hydrophobic membrane.

In some examples of the aerator system, the flow portion of the elongated rod can be a solid rod having one or more protrusions extending away from an outer surface of the solid rod to define the flow path between the outer surface of the solid rod and an inner surface of the hydrophobic membrane.

In some examples of the aerator device, the one or more protrusions can define a helical path around the outer surface of the flow portion, the helical being disposed between the outer surface of the solid rod and the inner surface of the hydrophobic membrane as the flow path.

In some examples of the aerator system, the one or more protrusions can include a plurality of separate protrusions spaced about the outer surface of the solid rod.

In some examples of the aerator system, the aerator device can be configured to aerate the liquid fluid flow with bubbles that are 200 micrometers or less.

In some examples of the aerator system, the aerator device can be configured to aerate the liquid fluid flow with bubbles that are 1 micrometer or less.

In some examples of the aerator system, the aerator device can be configured to aerate the liquid fluid flow with bubbles that are 200 nanometers or less.

In some examples of the aerator system, an outer surface of the flow portion where the gaseous fluid is configured to be released to the liquid fluid flow can be configured to be perpendicular to the liquid fluid flow within the conduit.

In some examples of the aerator system, the hydrophobic membrane can be made of Teflon, polyethelene, polypropylene, ethylene-propylene, HDPE, or combinations thereof.

In some examples of the aerator system, the hydrophobic membrane can be made of a material having a hydrophobicity of a predetermined level or greater.

In some examples of the aerator device, the hydrophobic membrane can be made of a material having a contact angle of at least 90 degrees.

In some examples of the aerator device, the elongated rod can be made of one or more of stainless steel, titanium, HDPE, CPVC, PEX, Kynar, polycarbonate, fluoroelastomers (e.g. VITON), and ethylene acrylic elastomers (e.g. VAMAC), polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, and high density polyethylene (HDPE). In short, the elongated rod can be made of any materials capable of structurally supporting the hydrophobic membrane in the conduit with liquid fluid flow. Also, if the hydrophobic membrane is sufficiently stiff, the elongated rod can be significantly shortened.

In some examples of the aerator system, the aerator device can be disposed concentrically within the conduit.

In some examples of the aerator system, multiple parallel elongated rods individually cladded in a hydrophobic membrane can be fed from a gas fluid manifold, and the bundle disposed concentrically within the conduit.

In some examples of the aerator system, the conduit can include a first portion that defines a portion of the liquid fluid flow within the conduit where the flow is unobstructed by the aerator device, and a second portion that defines a portion of the liquid fluid flow within the conduit where the aerator device is disposed. The aerator device disposed in the second portion of the conduit can cause the second portion to form a Venturi throat such that the liquid fluid flow is constricted in the second portion relative to the first portion such that the liquid fluid flow has increased velocity and decreased pressure in the second portion of the conduit.

The elongated rod can provide structural support for the membrane in the conduit. Thus, in one example, a hollow membrane tube with sufficient wall thickness/stiffness and a tapered arrowhead concentrically in the conduit to withstand the flowing liquid can be used without a supporting elongated rod. This configuration can allow perpendicular gaseous fluid flow to the direction of liquid fluid flow.

A method of aerating a fluid can include placing an aerator device into a liquid fluid flow of a conduit defining a fluid flow path for a liquid fluid flow. The aerator device can be configured to be inserted into a liquid fluid flow within a conduit. The aerator can include an elongated rod defining a flow path configured to direct a flow of a gaseous fluid, the flow path being separate from the liquid fluid flow. The elongated rod can include a flow portion defining the flow path configured to carry the gaseous fluid and configured to release the gaseous fluid into the liquid fluid flow. The elongated rod can further include a leading end disposed upstream from the flow portion within the liquid fluid flow. The leading end can be exposed to the liquid fluid flow. The aerator device can further include a hydrophobic membrane in fluid communication with at least the flow portion of the elongated rod such that the gaseous fluid released from the flow portion of the elongated rod is released to the liquid fluid flow through the hydrophobic membrane.

In some examples of the method the conduit can include a first portion that defines a portion of the liquid fluid flow within the conduit where the flow is unobstructed by the aerator device, a second portion that defines a portion of the liquid fluid flow within the conduit where the aerator device is disposed. The aerator device disposed in the second portion of the conduit can cause the second portion to form a Venturi throat such that the liquid fluid flow is constricted in the second portion relative to the first portion such that the liquid fluid flow has increased velocity and decreased pressure in the second portion of the conduit.

In some examples of the method, an outer surface of the flow portion where the gaseous fluid is configured to be released to the liquid fluid flow can be configured to be perpendicular to the liquid fluid flow within the conduit.

In some examples, the gaseous fluid can be at least one of argon, air, oxygen, ozone, CO₂, or any combinations thereof. Any desired gaseous fluid can be used as the gaseous fluid to aerate a liquid.

There has thus been outlined, rather broadly, certain features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side view of an assembled aerator system including an aerator device according to at least one example of the present disclosure.

FIG. 2 is a perspective view of the assembled aerator system of FIG. 1.

FIG. 3 is an exploded view of a disassembled aerator system of FIG. 1.

FIG. 4 illustrates a perspective view of an aerator device within the aerator system of FIG. 1, where the conduit that surrounds the aerator device has been removed according to at least one example of the present disclosure.

FIG. 5 illustrates a perspective view of an aerator device within the aerator system of FIG. 1, where the conduit that surrounds the aerator device has been removed and a tapered end is disposed on the aerator device according to at least one example of the present disclosure.

FIG. 6 illustrates a perspective view of a flow of liquid and gas into the aerator system of FIG. 1 according to at least one example of the present disclosure.

FIG. 7A illustrates a schematic of the aerator system with the aerator device disposed within the conduit of the aerator system and nanobubbles being introduced into the liquid fluid flow according to at least one example of the present disclosure.

FIG. 7B illustrates a portion of an elongated rod of the aerator device according to at least one example of the present disclosure.

FIG. 8A illustrates a side view of an aerator device according to at least one example of the present disclosure.

FIG. 8B illustrates a top view of the aerator device of FIG. 8B.

FIG. 8C illustrates a portion of the elongated rod of the aerator device of FIG. 8B and FIG. 8C disposed within a hydrophobic membrane, in accordance with at least one example of the present disclosure.

FIG. 9 illustrates a portion of an elongated rod of an aerator device disposed within a hydrophobic membrane, in accordance with at least one example of the present disclosure.

FIG. 10 illustrates a portion of an elongated rod of an aerator device disposed within a hydrophobic membrane, in accordance with at least one example of the present disclosure.

FIG. 11A is a schematic illustration of operation of the aerator device of FIG. 7A oriented within a conduit in a quiescent liquid, in accordance with another example of the present disclosure.

FIG. 11B is a schematic illustration of operation of the aerator device of FIG. 7A oriented within a conduit in a liquid fluid flow, in accordance with another example.

FIG. 12A is a schematic illustration of an aerator device oriented within a conduit in accordance with another example.

FIG. 12B is a cross-section view of the conduit of FIG. 12A taken along line A1.

FIG. 12C is a cross-section view of the conduit of FIG. 12A taken along line A2.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While the various examples are described in sufficient detail to enable those skilled in the art to practice the invention, it should be understood that other embodiments may be realized and that various changes to the invention may be made without departing from the spirit and scope of the present invention. Thus, the following more detailed description of the examples of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a conduit” includes reference to one or more of such channels and reference to “the membrane” refers to one or more of such features.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Operational Principles and Aerator

Aerating liquids with micro/nano bubbles provides a much larger and longer lasting quantity of gas in a liquid than larger bubbles that are introduced into a liquid. For example, large gas bubbles (e.g. >65 μm) in liquid may rise, expand, and disappear from a liquid column once reaching the liquid surface (according to Stokes's equation: U=ρgd²/18μ where U, ρ, g, d, μ are rising velocity, density of the liquid, gravitational acceleration constant, diameter, and dynamic viscosity of the liquid, respectively).

Air bubbles of 100 μm in diameter rise at 33 cm/min in water of 20 °C. In contrast, smaller bubbles of 10 μm rise much slower at 0.33 cm/min, thereby prolonging gas transfer into liquid that leads to bubble shrinkage. The shrinkage of the bubbles is due to both gas dissolution and high internal pressure of the bubble that arises from liquid surface tension at small bubble sizes (e.g., micro and nano bubbles). For example, the internal pressure of the bubble is equal to P=4σ/d, where P is the internal pressure, σ is the liquid surface tension and d is the bubble diameter). In one specific example, at 20°C, the internal pressure of small bubbles is 2.9 atm for 1-μm diameter and 290 atm for 0.01-μm (or 10 nm). The high internal gas pressure (P) corresponds to a high equilibrium (saturation) gas concentration C* according to Henry's Law (i.e. C*=K_{H} P; where K_{H} is the Henry's law constant). This results in a high concentration gradient (C*-C) where C is the actual dissolved gas concentration. This high concentration gradient (C*-C) is what drives mass transfer of gas from the bubble to the liquid phase, which is determined by K_{La}(C*-C) where K_{La} is the overall mass transfer coefficient. The high concentration gradient leads to a high gas transfer rate into liquid and thus cause the bubble's shrinkage. Once in submicron ranges (i.e. nano sizes), the gas bubbles now become stable over days, weeks, or longer because of the negative charge of OH− ions accumulated at the interface between the bubble surface and the liquid, preventing the bubbles from further shrinkage. The abundant interface attracts and concentrates surfactant molecules for increased exposure of substances and organisms in the aerated liquid to the gaseous fluid that make up the bubbles.

Although mechanical aerators that enable gas concentrations transfer into liquids have been developed, energy expenditure to maintain sufficiently high-dissolved gas concentrations, particularly for high-value applications, remains an area of improvement for sustainable aquaculture. Described herein is an aerator device that introduces micro or nano bubbles in liquid fluids (e.g., liquid) with higher efficiency and lower power consumption than is currently used. Additionally, the aerator device described herein is simpler and less expensive than other aerators. In order to create long lasting micro/nano bubbles in a liquid and to increase a level of gas concentrations in the liquid, the aerator device(s) described herein can operate according to the principles described above regarding micro and nano bubble characteristics in liquids. To create bubbles of a desired size so that the bubbles are stable, long-lasting, and that shrink in the liquid instead of rising quickly and dissipating, an aerator device according to the present disclosure can create bubbles that are 65 μm or less. Although larger bubbles tend to dissipate faster than smaller bubbles, it can still be beneficial to aerate the liquid with bubbles that are 200 μm or less. To get better results however, the bubbles can be 65 μm or less. Bubbles that are 1 micrometer or less can be even more beneficial and bubbles that are 200 nanometers or less can be even more beneficial. Accordingly, the aerator device described herein can be capable of producing bubbles having a size between 200 μm to 200 nanometers, or even less.

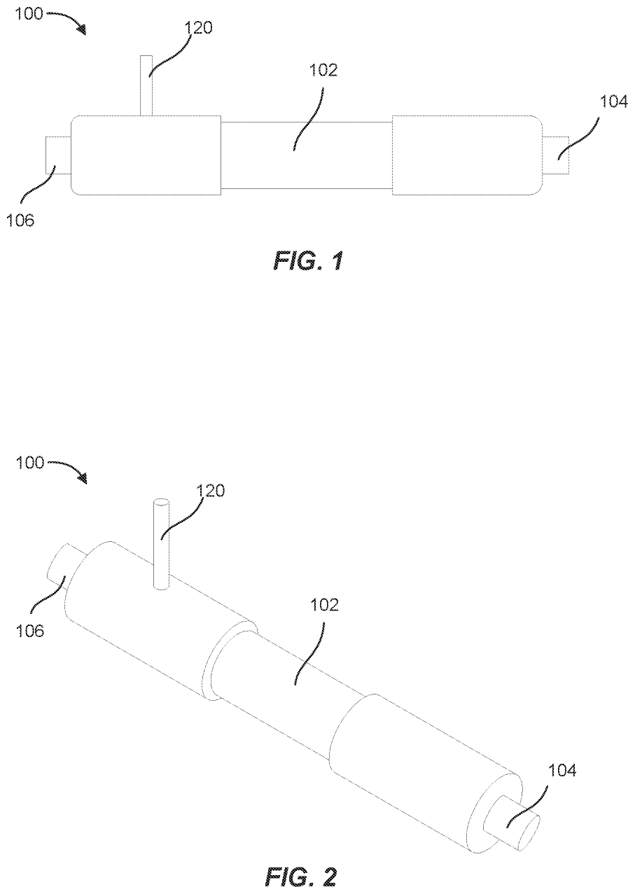

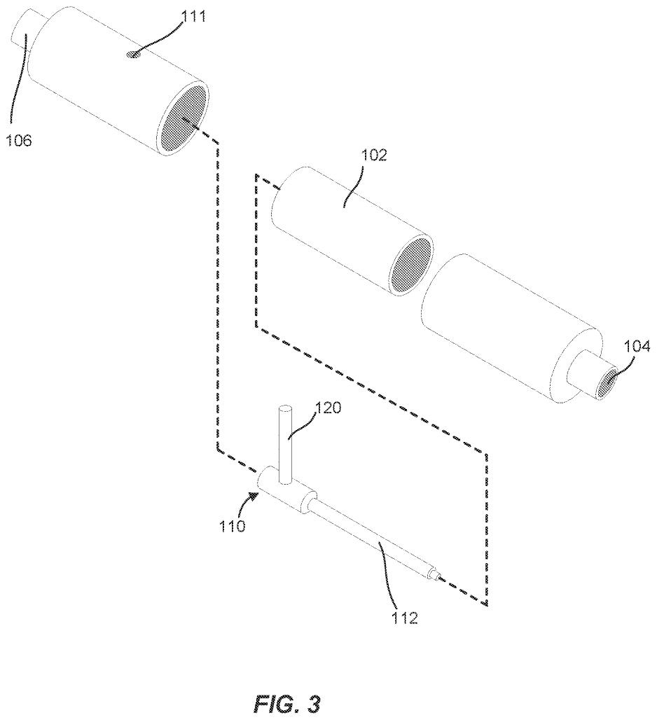

Aerator devices in accordance with the present disclosure will be described with reference to the attached figures. FIG. 1 and FIG. 2 respectively illustrate a side view and a perspective view of an aerator system 100 in accordance with at least one example of the present disclosure. FIG. 3 illustrates an exploded view of the aerator system 100. As shown in FIGS. 1-3, the aerator system 100 can include a conduit 102 defining a fluid flow path for a liquid fluid flow. The conduit 102 can include a fluid inlet 104 and a fluid outlet 106 through which the liquid fluid can enter and exit the conduit 102. The liquid in this case can be water. However, it is to be understood that the liquid is not limited to water and can be any liquid that is desired to be aerated by the aerator system 100 described herein, without any intended limitation. The aerator system 100 can further include an aerator device 110 disposed within the conduit 102. The aerator device 110 can include an elongated rod 112 defining a flow path configured to direct a flow of a gaseous fluid. The flow path can be separate from the liquid fluid flow.

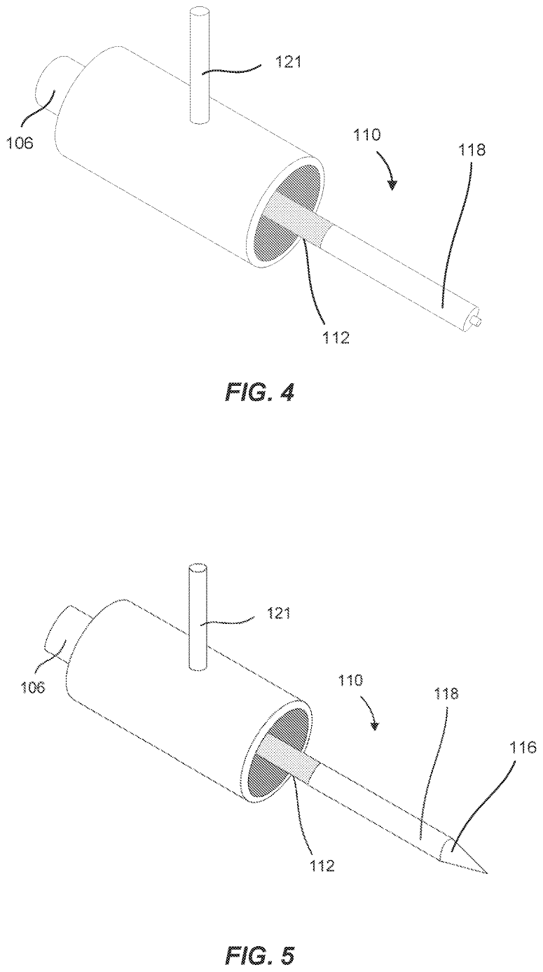

FIGS. 3-6 illustrate further views of the aerator device 110 with at least a portion of the aerator system 100. As illustrated, the aerator device 110 can further include a gas inlet 120 where gaseous fluid is introduced to flow within the elongated rod 112 of the aerator device 110. The gas inlet 120 can be at least partially inserted into a hole 111 formed in the aerator system 100 and configured to receive the gas inlet 120 of the aerator device 110, as shown in FIG. 3.

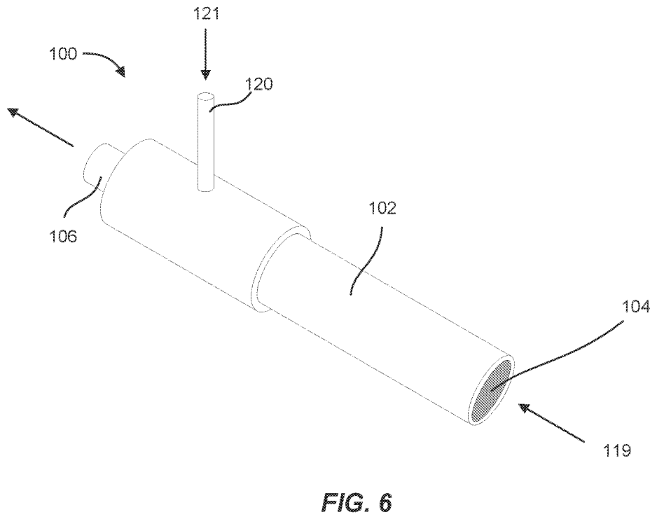

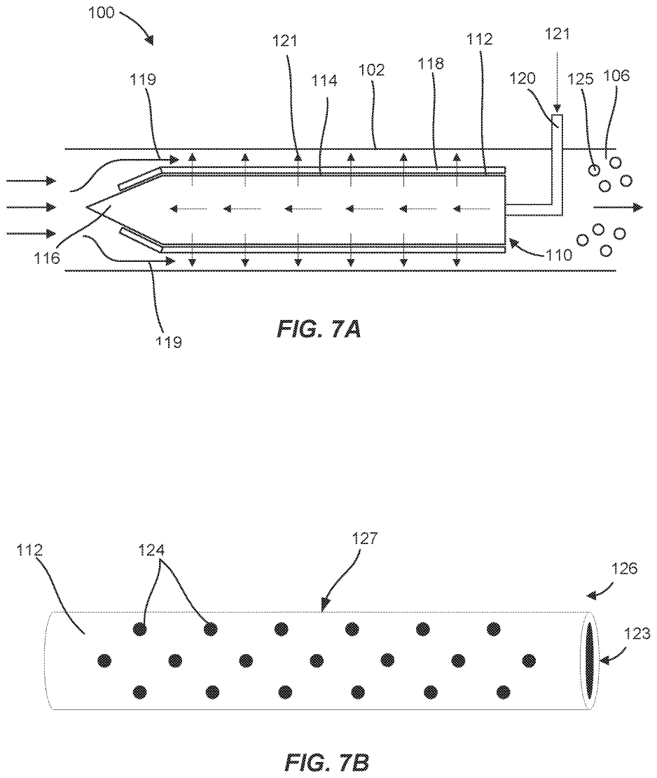

FIG. 6 illustrates a direction of gaseous fluid flow 121 into the aerator system 100 through a gas inlet 120 of the aerator device 110 and a liquid fluid flow 119 into the aerator system 100 through fluid inlet 104 and out of the aerator system 100 through the fluid outlet 106. A cross section of the aerator system 100 with the aerator device 110 disposed in the conduit 102 is illustrated in FIG. 7A. As illustrated in FIG. 7A, the elongated rod 112 can include a flow portion 114 defining the flow path configured to carry the gaseous fluid and configured to release the gaseous fluid into the liquid fluid flow 119. The flow portion 114 can define the flow path of the gaseous fluid over the gaseous fluid flow 121 to be on an inside of the elongated rod 112 and/or the flow portion 114. For example, the flow portion 114 of the elongated rod 112 can be a hollow tube defining the flow path for the gaseous fluid on an inside of the elongated rod 112. In other words, the elongated rod 112 can itself be formed as a hollow tube such that the gaseous fluid flow 121 flows within the inside of the elongated rod 112 acting as the flow portion 114. The elongated rod 112 can further include a tapered leading end 116 disposed upstream from the flow portion 114 of the elongated rod 112 and within the liquid fluid flow 119 in the conduit 102, such that the tapered leading end 116 is exposed to the liquid fluid flow 119.

As illustrated in FIG. 7B, the elongated rod 112 (e.g., in the flow portion 114) can be a hollow tube. The hollow tube can be porous and/or finely perforated to allow gaseous liquids of the gaseous fluid flow 121 inside the elongated rod 112 to pass from an inside 123 of the elongated rod 112 to an outside 126 of the elongated rod 112 through one or more pores 124 formed in an outer surface 127 of the hollow tube. The pores 124 can be formed in the elongated rod through drilling, sintering, puncturing, or any known method without limitation. The aerator device 110 can further include a hydrophobic membrane 118 surrounding the elongated rod 112 and in fluid communication with at least the flow portion 114 of the elongated rod 112. Accordingly, the gaseous fluid of the gaseous fluid flow 121, having passed through one or more pores formed in the elongated rod 112 (e.g., the hollow tube), can then pass through the hydrophobic membrane 118 to enter the liquid fluid flow 119 in the conduit 102.

As further shown in FIG. 7A, an outer surface of the flow portion 114 where the gaseous fluid 121 is configured to be released to the liquid fluid flow 119 is configured to be parallel to the liquid fluid flow 119 within the conduit 102. In other words, the gaseous fluid flow 121 is released to the liquid fluid flow 119 in a direction perpendicular to the liquid fluid flow 119. Nano or micro bubbles 125 are created in the liquid by passage of the gaseous fluid flow 121 into the liquid fluid flow 119.

In an alternative configuration to the hollow tube-shaped elongated rod 112 described above with reference to FIGS. 1-7B, it is to be understood that the elongated rod 112 itself can be shaped as a hollow tube that is made of a stiff hydrophobic membrane material that is strong enough to hold shape and position within the liquid fluid flow. In such a configuration it is not necessary to include both a separate rod and a hydrophobic membrane, thereby simplifying the structure of the aerator device 110. In other words, in place of the elongated rod 112 and the hydrophobic membrane 118, a single stiff membrane tube to which a gas steel tube is inserted to supply gas can be used as the elongated rod without needing a separate elongated rod and hydrophobic membrane.

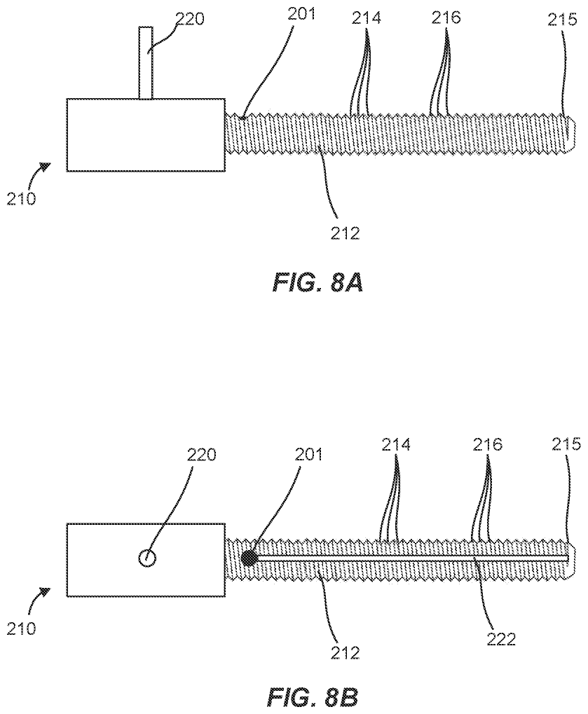

Alternative configurations of the aerator device are described with reference to FIGS. 8A-10. In an alternative configuration shown in FIGS. 8A-8C, an aerator device can have an elongated rod 212 that is a solid rod and a gas inlet 220. A shown in FIGS. 8A and 8B, the elongated rod can be a solid elongated rod 212 similar to a bolt or screw. The elongated rod 212 can have a flow portion 214 of the elongated rod 212 that is formed as a path along the outside surface of the elongated rod 212. For example, the flow portion 214 can be, as shown in FIGS. 8A-8C, a helical path around an outside of the elongated rod 212 between protrusions 216 that define the path of the flow portion 214. However, it is to be understood that the shape of the path of the flow portion 214 is not intended to be limited in any way by this disclosure. For example, the path of the flow portion can be helical, straight, curved, jagged, random, or any other shape without any intended limitation. Furthermore, the path of the flow portion 214 can be formed either by forming protrusions 216 on the outer surface 215 of the elongated rod 212 to define a path of the flow portion 214 in between the protrusions 216. Alternatively, or additionally, the path of the flow portion 214 can be defined by cutting or other material removal processes performed on the outer surface 215 of the elongated rod 212.

The aerator device 210 can further include an opening 201 in fluid communication with the gas inlet 220 disposed to introduce the gaseous fluid flow to the flow portion 214 of the elongated rod 212. In FIGS. 8A and 8B, the opening 201 is formed in the outer surface 215 of the elongated rod. However, the position of the outer surface 215 is not intended to be so limited by this disclosure. The opening 201 can be disposed at any position on the aerator device 210 that allows for fluid communication between the opening 201 and the gas inlet 220 and allows for introduction of the gaseous fluid into the flow portion 214.

As illustrated in FIG. 8C, the one or more protrusions 216 extending away from an outer surface 215 of the solid elongated rod 212 can define the flow path of the flow portion 214 between the outer surface 215 of the elongated rod 212 and an inner surface 217 of the hydrophobic membrane 218. The protrusions 216 can include a helical protrusion 216 surrounding the solid elongated rod 212 defining a helical path as the flow portion 214 in spaces between the protrusions 216 of elongated rod 212 and the hydrophobic membrane 218. The flow path of the flow portion 214 can provide for flow of the gaseous liquids flowing along the solid elongated rod 212 between the elongated rod 212 and the hydrophobic membrane 218. As one alternative, an optional express channel 222 can be cut longitudinally across the protrusions 216 of elongated rod 212. This can allow for even distribution of gas across the membrane. Such an express channel can be introduced into the other variations as well (i.e. those discussed below and in connection with FIGS. 9-12C).

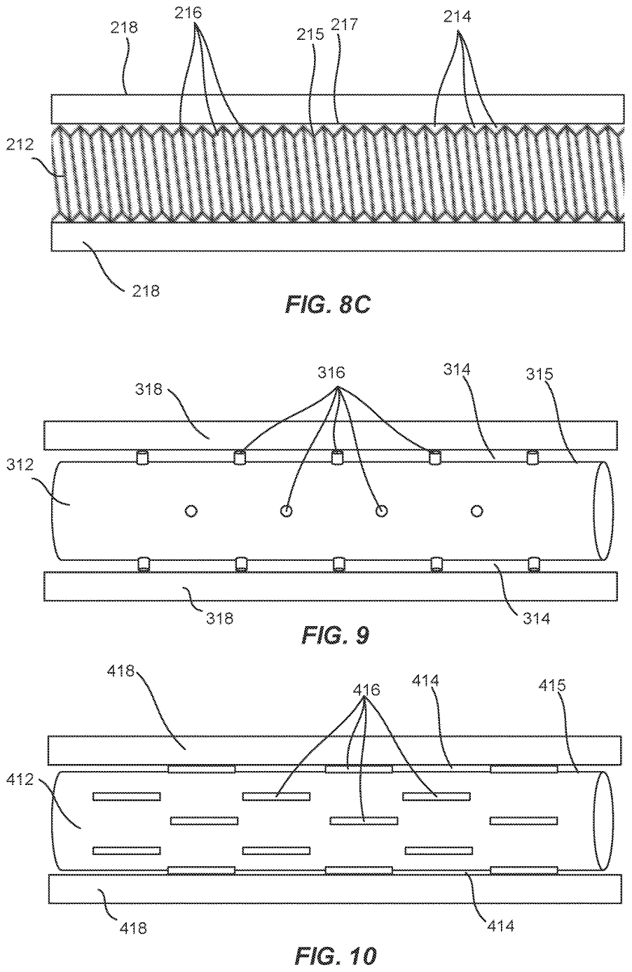

Alternative to the example illustrated in FIGS. 8A-8C, examples are shown in FIGS. 9 and 10 in which a plurality of separate protrusions along an outer surface of the solid rod can be used to define the flow path between an outer surface of the elongated rod and the hydrophobic membrane. For example, FIG. 9 illustrates a solid elongated rod 312 within a hydrophobic membrane 318 and including a plurality of protrusions 316 spaced about the rod 312 and defining a flow path 314 along the elongated rod 312 between an outer surface 315 of the elongated rod 312 and the hydrophobic membrane 318. The protrusions can be disposed on the solid elongated rod 312 in any arrangement and orientation that allows a flow path to be defined as the flow portion 314 between the solid elongated rod 312 and the hydrophobic membrane 318. The shape, spacing, and/or configuration of the protrusions 316 is not intended to be limited by this disclosure in any way.

FIG. 10 illustrates an alternative shaping and configuration of protrusions 416 along a solid elongated rod 412. The solid elongated rod 412 is disposed within a hydrophobic membrane 418 and includes a plurality of protrusions 416 spaced about the outer surface 415 of the elongated rod 412 and defining a flow path 414 along the elongated rod 412. The protrusions 416 can be disposed on the solid elongated rod 412 in any arrangement and orientation that allows a flow path to be defined as the flow portion 414 between the outer surface 415 of the solid elongated rod 412 and an inner surface of the hydrophobic membrane 418.

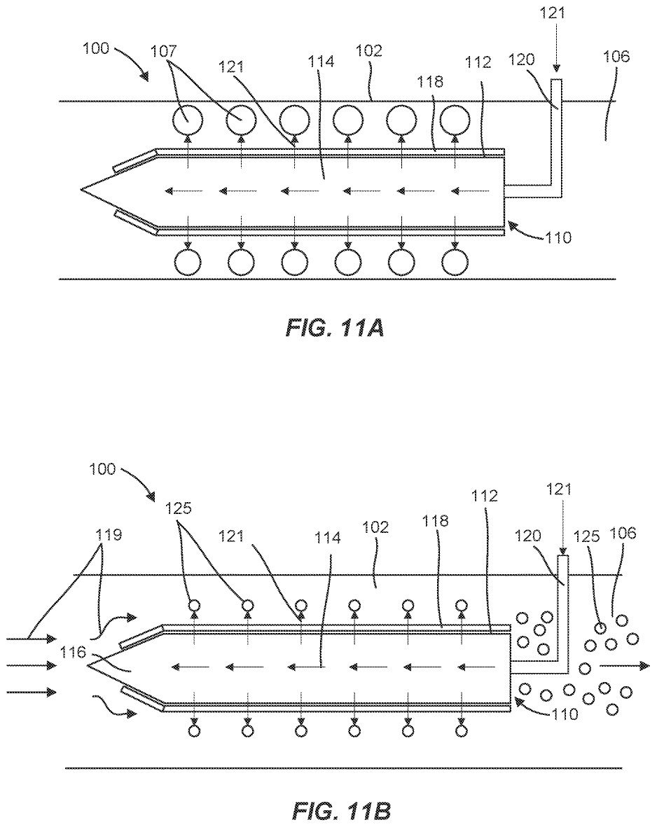

FIG. 11A illustrates operation of the aerator system 100, and the aerator device 110 within the conduit 102 based on observed experiments carried out by the inventors. It is to be understood that any of the aerator devices described herein (e.g., aerator devices 110 and/or 210) can operate similarly within the conduit 102 to produce micro and/or nano bubbles. FIG. 11A shows the aerator device disposed that large gas bubbles 107 emerging from the hydrophobic membrane 118 in a quiescent liquid. In FIG. 11B, a liquid fluid flow 119 is introduced in to the conduit 102 at a flow rate induced by a pump or other liquid driving force. The liquid fluid flow 119 in the conduit 102 can be in a range of laminar flow or any other desired velocity based on application or user defined parameters. As shown in FIG. 11B, the emerging bubbles 125 emerge at sizes that are significantly reduced when liquid starts to flow compared to the bubbles 107 emerging in quiescent liquid shown in FIG. 11A. In FIG. 11B, continual gas is emerging as small, hardly discernible bubbles 126 at a steady state of liquid and gaseous fluid flow within the conduit 102 and aerator device 110. Bubble concentration and size distribution caused by the aerator device operating in the conduit is observable in liquid using a dynamic light scattering (DLS) technique. For example, DLS can be used on a first bottle of a non-aerated liquid and a second bottle of a liquid aerated with the aerator devices and systems described herein. In DLS, a laser light is directed through both bottles. The nanobubbles in the aerated bottle disperse the laser light leaving a visible trail of bubbles in the aerated bottle while little to no visible trail of bubbles is seen in the non-aerated bottle.

As a general guideline, the hydrophobic surface causes the bubbles to emerge approximating a spherical shape at the hydrophobic membrane surface (with contact angle >90°). As it grows bigger, it experiences the interfacial adhesive force holding it to the surface. In a quiescent environment (no liquid flow) it also experiences an increasing buoyancy force lifting it from the surface. The bubble is held until the lifting buoyancy force (increasing due to growing size) wins over the adhesive interfacial force (increasing less because of slower contact area increase), allowing the bubble to detach. The bubbles typically grow to sub-centimeter sizes before they are lifted from the surface, releasing in sub-centimeter size bubbles even though the membrane's pore sizes are in the micron or submicron ranges. In the present aerator devices, using shearing liquid in the conduit, the bubbles experience a strong shearing force to push them off the surface that wins over the adhesive force sooner. The actual fluid dynamics is much more complex, but this summary is sufficient for purposes of this invention. Thus, instead of seconds for the bubbles to grow bigger in a quiescent environment, the water-flowing conduit allows much less time to do so, thus creating nanobubbles determined by growth time and liquid velocity. Short growth time (duration of the bubble from initial appearance to detachment from surface) allows production of nanobubbles. Short growth time can be achieved by adjusting other parameters such as membrane tube size, conduit size, gas flow rate, liquid flow rate, and membrane hydrophobicity.

A plurality of material choices are available for the conduit, the elongated rod, and the hydrophobic membrane. For example, the elongated rod of the aerator device can be a finely perforated stainless-steel, a porous stainless steel, or any other suitable material. Any inert materials can be used which are capable of maintaining structural support for the membrane tube against liquid fluid flow and unreactive toward the gas stream, such as but not limited to stainless steel, titanium, HDPE, CPVC, PEX, Kynar, polycarbonate, fluoroelastomers (e.g. VITON), and ethylene acrylic elastomers (e.g. VAMAC), polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, and high density polyethylene (HDPE), composites thereof, and the like. In one example, the material can be ozone resistant. The gas-dispersing elongated rod can be cladded in a porous hydrophobic membrane sleeve and placed in a liquid pipe with a streamlined arrowhead pointing toward the oncoming liquid fluid flow. The hydrophobic membrane can be formed of a Teflon, polyethelene, or polypropylene material. Other candidate inert materials resistant to the gas and liquid can include, but are not limited to, ethylene-propylene, HDPE, polyethylene, polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, etc. The hydrophobic membrane can be made of a material having a contact angle >90°. Materials with high contact angles (e.g., >90°) are considered hydrophobic. The higher contact angle, the more hydrophobic the material. For example, a highly hydrophobic material such as Teflon (PTFE) has a contact angle at 115°. The conduit can be constructed of any material suitable to confine and direct a fluid flow.

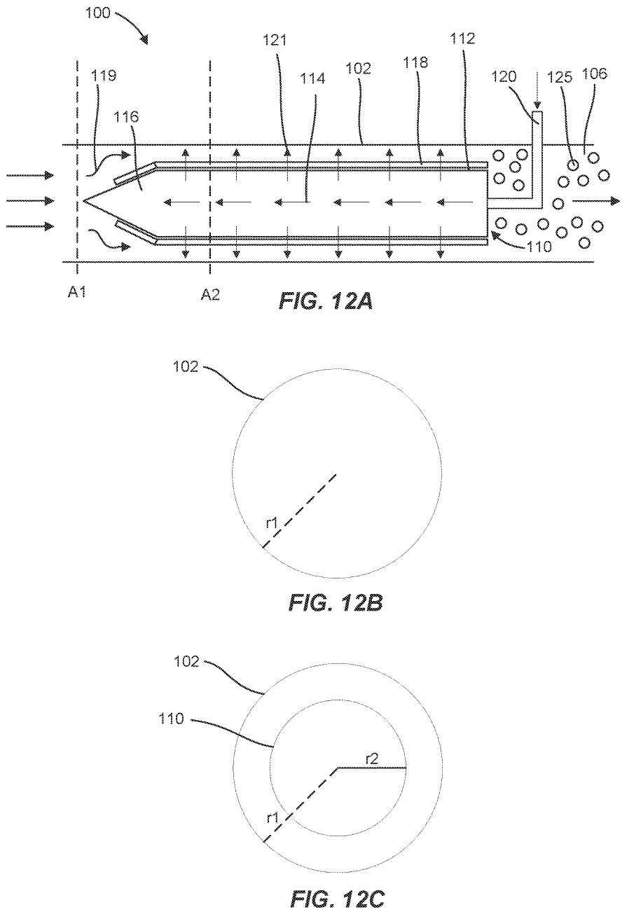

Liquid fluid flow along the conduit over the aerator device 110 is constricted because of the aerator device 110 placement in the flow path of the conduit 102 as shown in FIGS. 12A-12C. This constriction of the conduit facilitates the formation of micro and nanobubbles in a liquid. For example, two cross sections of the aerator system 100 are shown in FIGS. 12B and 12A. FIG. 12B is a cross section taken along line A1 in FIG. 12A and FIG. 12C is a cross section taken along line A2 in FIG. 12A. In FIG. 12B, the flow cross-sectional area is equal to an interior of the conduit 102, which is πr₁². However, the flow is constricted in an area where the aerator device 110 is disposed (area A2) where the area equals (πr₁²−πr₂²). The restricted flow causes the aerator system to behave as a Venturi, in which liquid fluid flow accelerates through the throat, creating low pressure to draw the gas into the flowing liquid through the lower pressure at the constricted zone A2 (i.e. Venturi throat) that draws gas into the liquid fluid flow through the aerator body as governed by the Bernoulli equation. The repeated compression and decompression cycles in the Venturi series provide the agitation, mixing, shearing, enhancing processes occurring at the bubble interface. This can be useful for contaminant treatment, disinfection, and breaking apart contaminated soil aggregates for treatment. Due to the Venturi effect, the gas bubbles emerge at the aerator membrane surface and are sheared off as small bubbles from the surface by the flowing liquid. The growth of gas bubbles as they emerge and the size at separation are controlled by these process parameters: hydrophobicity/hydrophilicity of the aerator's membrane surface, pore size and surface roughness of the membrane, gas pressure of the aerator, and liquid velocity, which in turn determine the contact angle (height) and the shear force on the emerging bubbles. The operation conditions can be selected to create desirable bubble sizes (e.g. <60 μm) that will shrink further into nano sizes and become stable.

Venturis can provide a low-pressure zone at the throat. The dimensions of Venturis (i.e., throat-to-wall diameter ratios) can be varied to create a range of pressure differentials according to applications and or desires. The pressure differentials can range from mild pressure differentials to large differentials sufficient to cause liquid cavitation.

The dimensions of the rod and conduits can be varied. As a general guideline, a smaller rod cladded in smaller membrane tube provides a higher curvature that releases bubbles to the shearing liquid sooner (i.e. making smaller bubbles). Without limiting the disclosure to any specific theory, it has been observed by the inventors that the interfacial force (adhesive force) holding the bubble to the membrane surface is reduced by the curved surface in contrast to a flatter surface of a larger membrane tube. There are other factors that can be relevant to nano or microbubble production such as liquid flow velocity, which is influenced by the conduit size given the same pump power. As a general guideline, high liquid fluid flow velocity tends to shear off bubbles sooner than smaller liquid fluid flow velocities). Thus, the ratio of liquid flow velocity to gas flowrate can be chosen accordingly to achieve a desired target bubble size. As another general guideline, more gas can be turned into nanobubbles faster when higher liquid fluid flow velocity rates are used. Membrane curvature (i.e. tube size), gas flowrate, liquid flow velocity are also relevant factors to consider and to vary in order to create nanobubbles in a desired density and at a desired nanobubble size. In general, a tube and a conduit that are small enough to allow strong shearing along the membrane tube can be suitable for creation of the nano and microbubbles. As one example, a membrane tube size of external diameter from ¼″ to 1″ can be used, but can also depend on the scale of application.

Control parameters that determine bubble size distribution further include: segment lengths, length ratio, diameters, and diameter ratios of the aerator and pipe, aerator surface roughness, inlet pressure (negative to positive) of the aerator device, and liquid flow velocity. Parameters can be varied and evaluated to select workable ranges based on generated bubble sizes/properties. The devices and methods presented herein can be used to form nanobubbles of many gases. Non-limiting examples can include argon, air, oxygen, ozone, CO₂, and any combinations of these gases. For example, the device can be used with air/O₂ for growth of plants and animals and ecological health, ozone for disinfection, ozone for contaminant degradation, CO2 for carbon sequestration, methane for plant health, hydrogen into gasoline for engine efficiency, etc. In short, it is to be understood that any gas can be used to create the gas fluid flow in the aerator systems and devices described herein, without any intended limitation.

While nanobubbles possess enormous potential to positively impact physiological responses of living organisms, the production of nanobubbles in large quantity remains economically challenging. Many methods have been attempted based on different principles including electrolysis, ethanol-liquid exchange, decompression, turbulent jet flows, acoustic cavitation, emulsions, pressurization through membrane, hydrodynamic cavitation, external electric fields, magnetic field, among others. These techniques generate varied, often limited amounts of Nanobubbles while the costs of generation and the energy expended have been undesirably high, which hampered wide adoption of current nanobubble producing methods in aquaculture.

In contrast, the aerator devices and systems described herein exhibit several benefits and advantages for the art of liquid aeration. The aerator devices and systems described herein exhibit more energy efficiency (i.e., a ratio of the # of nanobubbles produced to the energy expended is higher) compared to other aerator devices and systems. In other words, the aerator devices described herein have lower energy requirements compared previous aerators and exhibit a rich production of nanobubbles. As shown in FIG. 11A, large gas bubbles emerge from the hydrophobic membrane-cladded rod in a quiescent liquid. However, emerging sizes of bubble significantly reduce when liquid starts to flow over the hydrophobic membrane as in FIG. 11B. At steady state gas and liquid fluid flow, gas emerges as small, hardly discernible bubbles into the liquid fluid flow as shown in FIG. 11B. Furthermore, scattering of a laser beam within an aerated liquid reveals the presence of nanobubbles in liquid after aeration by the aerator devices and systems described herein. For example, the inventors found through measurements of Dynamic Light Scattering (DLS) and Nanoparticle Tracking Analysis (NTA) that nanobubbles ranged from 10 to 200 nm in size at concentration on the order of 10⁷ to 10⁹ NB/mL after 15 min of aeration using aerator devices and systems as described herein.

### CLAUSES

For purposes of clarity, additional variations of the aerator device can include

Clause 1: An aerator device configured to be inserted into a liquid fluid flow within a conduit, the aerator device comprising:
an elongated rod defining a flow path configured to direct a flow of a gaseous fluid, the flow path being separate from the liquid fluid flow, the elongated rod comprising:
   a flow portion defining the flow path and configured to release the gaseous fluid into the liquid fluid flow; and
   a leading end disposed upstream from the flow portion within the liquid fluid flow, the leading end being exposed to the liquid fluid flow; and
   a hydrophobic membrane in fluid communication with at least the flow portion of the elongated rod such that the gaseous fluid released from the flow portion of the elongated rod is released to the liquid fluid flow through the hydrophobic membrane.

Clause 2: The aerator device of any clause, wherein the leading end of the elongated rod is tapered.

Clause 3: The aerator device of any clause, wherein the flow portion of the elongated rod comprises a hollow tube defining the flow path for the gaseous fluid on an inside thereof.

Clause 4: The aerator device of any clause, wherein the hollow tube comprises one or more pores formed through an outer surface thereof to allow the gaseous fluid to pass from the flow path, through the one or more pores of the hollow tube, and through the hydrophobic membrane.

Clause 5: The aerator device of any clause, wherein the elongated rod is formed of the hydrophobic membrane.

Clause 6: The aerator device of any clause, wherein the flow portion of the elongated rod comprises a solid rod comprising one or more protrusions extending away from an outer surface of the solid rod to define the flow path between the outer surface of the solid rod and an inner surface of the hydrophobic membrane.

Clause 7: The aerator device of any clause, wherein the one or more protrusions define a helical path between the outer surface of the solid rod and the inner surface of the hydrophobic membrane as the flow path.

Clause 8: The aerator device of any clause, wherein the one or more protrusions comprise a plurality of separate protrusions spaced about the outer surface of the solid rod.

Clause 9: The aerator device of any clause, wherein the aerator device is configured to aerate the liquid fluid flow with bubbles that are 200 micrometers or less.

Clause 10: The aerator device of any clause, wherein the aerator device is configured to aerate the liquid fluid flow with bubbles that are 1 micrometer or less.

Clause 11: The aerator device of any clause, wherein the aerator device is configured to aerate the liquid fluid flow with bubbles that are 200 nanometers or less.

Clause 12: The aerator device of any clause, wherein the hydrophobic membrane is made of polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, HDPE, or combinations thereof.

Clause 13: The aerator device of any clause, wherein the hydrophobic membrane is made of a material having a contact angle of at least 90°.

Clause 14: The aerator device of any clause, wherein the elongated rod is made of one or more of stainless steel, titanium, HDPE, CPVC, PEX, Kynar, polycarbonate, fluoroelastomers (e.g. VITON), and ethylene acrylic elastomers (e.g. VAMAC), polytetrafluoroethylene (e.g. TEFLON), polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, and high density polyethylene (HDPE).

Clause 15: An aerator system comprising:
a conduit defining a fluid flow path for a liquid fluid flow; and
an aerator device disposed within the conduit, the aerator device comprising:
   an elongated rod defining a flow path configured to direct a flow of a gaseous fluid, the flow path being separate from the liquid fluid flow, the elongated rod comprising:
      a flow portion defining the flow path and configured to release the gaseous fluid into the liquid fluid flow; and
      a leading end disposed upstream from the flow portion within the liquid fluid flow, the leading end being exposed to the liquid fluid flow; and
   a hydrophobic membrane in fluid communication with at least the flow portion of the elongated rod such that the gaseous fluid released from the flow portion of the elongated rod is released to the liquid fluid flow through the hydrophobic membrane.

Clause 16: The aerator system of any clause, wherein the leading end of the elongated rod is tapered.

Clause 17: The aerator system of any clause, wherein the flow portion of the elongated rod comprises a hollow tube defining the flow path for the gaseous fluid on an inside thereof.

Clause 18: The aerator system of any clause, wherein the hollow tube comprises one or more pores formed through an outer surface thereof to allow the gaseous fluid to pass from the flow path, through the one or more pores of the hollow tube, and through the hydrophobic membrane.

Clause 19: The aerator system of any clause, wherein the flow portion of the elongated rod comprises a solid rod comprising one or more protrusions extending away from an outer surface of the solid rod to define the flow path between the outer surface of the solid rod and an inner surface of the hydrophobic membrane.

Clause 20: The aerator system of any clause, wherein the one or more protrusions define a helical path between the outer surface of the solid rod and the inner surface of the hydrophobic membrane as the flow path.

Clause 21: The aerator system of any clause, wherein the one or more protrusions comprise a plurality of separate protrusions spaced about the outer surface of the solid rod.

Clause 22: The aerator system of any clause, wherein an outer surface of the flow portion where the gaseous fluid is configured to be released to the liquid fluid flow is configured to be perpendicular to the liquid fluid flow within the conduit.

Clause 23: The aerator system of any clause, wherein aerator device is disposed concentrically within the conduit.

Clause 24: The aerator system of any clause, wherein the conduit comprises:
a first portion that defines a portion of the liquid fluid flow within the conduit where the flow is unobstructed by the aerator device; and
a second portion that defines a portion of the liquid fluid flow within the conduit where the aerator device is disposed,
wherein the aerator device disposed in the second portion of the conduit causes the second portion to form a Venturi throat such that the liquid fluid flow is constricted in the second portion relative to the first portion such that the liquid fluid flow has increased velocity and decreased pressure in the second portion of the conduit.

Clause 25: A method of aerating a fluid, the method comprising:
placing the aerator device of any clause into the liquid fluid flow of a conduit defining a fluid flow path for a liquid fluid flow; and
providing the gaseous fluid through the flow path defined by the aerator device and through the hydrophobic membrane into the liquid fluid flow.

Clause 26: The method of any clause, wherein the fluid is at least one of argon, air, oxygen, ozone, CO₂, and combinations thereof.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

1. An aerator device configured to be inserted into a liquid fluid flow within a conduit, the aerator device comprising:
an elongated rod defining a flow path configured to direct a flow of a gaseous fluid, the flow path being separate from the liquid fluid flow, the elongated rod comprising:
a flow portion defining the flow path and configured to release the gaseous fluid into the liquid fluid flow; and
a leading end disposed upstream from the flow portion within the liquid fluid flow, the leading end being exposed to the liquid fluid flow; and
a hydrophobic membrane in fluid communication with at least the flow portion of the elongated rod such that the gaseous fluid released from the flow portion of the elongated rod is released to the liquid fluid flow through an outer surface of the hydrophobic membrane, wherein the outer surface of the hydrophobic membrane is parallel to the liquid flow and is unobstructed.

2. The aerator device of claim 1, wherein the leading end of the elongated rod is tapered.

3. The aerator device of claim 1, wherein the flow portion of the elongated rod comprises a hollow tube defining the flow path for the gaseous fluid on an inside thereof.

4. The aerator device of claim 3, wherein the hollow tube comprises one or more pores formed through an outer surface thereof to allow the gaseous fluid to pass from the flow path, through the one or more pores of the hollow tube, and through the hydrophobic membrane.

5. The aerator device of claim 1, wherein the elongated rod is formed of the hydrophobic membrane.

6. The aerator device of claim 1, wherein the flow portion of the elongated rod comprises a solid rod comprising one or more protrusions extending away from an outer surface of the solid rod to define the flow path between the outer surface of the solid rod and an inner surface of the hydrophobic membrane.

7. The aerator device of claim 6, wherein the one or more protrusions define a helical path between the outer surface of the solid rod and the inner surface of the hydrophobic membrane as the flow path.

8. The aerator device of claim 6, wherein the one or more protrusions comprise a plurality of separate protrusions spaced about the outer surface of the solid rod.

9. The aerator device of claim 1, wherein the aerator device is configured to aerate the liquid fluid flow with bubbles that are 200 micrometers or less.

10. The aerator device of claim 1, wherein the aerator device is configured to aerate the liquid fluid flow with bubbles that are 1 micrometer or less.

11. The aerator device of claim 1, wherein the aerator device is configured to aerate the liquid fluid flow with bubbles that are 200 nanometers or less.

12. The aerator device of claim 1, wherein the hydrophobic membrane is made of polytetrafluoroethylene, polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, high density polyethylene (HDPE), or combinations thereof.

13. The aerator device of claim 1, wherein the hydrophobic membrane is made of a material having a contact angle of at least 90°.

14. The aerator device of claim 1, wherein the elongated rod is made of one or more of stainless steel, titanium, HDPE, CPVC, PEX, Kynar, polycarbonate, fluoroelastomer, ethylene acrylic elastomers, polytetrafluoroethylene, polyethylene, polypropylene, fluorinated ethylene propylene, perfluoroalkoxy alkane, ethylene tetrafluoroethylene (ETFE), polyvinylidene fluoride (PVDF), polypropylene (PP), polystyrene (PS), polyethylene (PE), polycarbonate (PC), polyurethane (PU), polyvinyl chloride (PVC), polyethylene terephthalate (PET), polymethyl methacrylate (PMMA), ethylene-propylene, and high density polyethylene (HDPE).

15. An aerator system comprising:
a conduit defining a fluid flow path for a liquid fluid flow; and
an acrator device disposed within the conduit, the aerator device comprising:
an elongated rod defining a flow path configured to direct a flow of a gaseous fluid, the flow path being separate from the liquid fluid flow, the elongated rod comprising:
a flow portion defining the flow path and configured to release the gaseous fluid into the liquid fluid flow; and
a leading end disposed upstream from the flow portion within the liquid fluid flow, the leading end being exposed to the liquid fluid flow; and
a hydrophobic membrane in fluid communication with at least the flow portion of the elongated rod such that the gaseous fluid released from the flow portion of the elongated rod is released to the liquid fluid flow through an outer surface of the hydrophobic membrane, wherein the outer surface of the hydrophobic membrane is parallel to the liquid flow and is unobstructed.

16. The aerator system of claim 15, wherein the leading end of the elongated rod is tapered.

17. The aerator system of claim 15, wherein the flow portion of the elongated rod comprises a hollow tube defining the flow path for the gaseous fluid on an inside thereof.

18. The aerator system of claim 17, wherein the hollow tube comprises one or more pores formed through an outer surface thereof to allow the gaseous fluid to pass from the flow path, through the one or more pores of the hollow tube, and through the hydrophobic membrane.

19. The aerator system of claim 15, wherein the flow portion of the elongated rod comprises a solid rod comprising one or more protrusions extending away from an outer surface of the solid rod to define the flow path between the outer surface of the solid rod and an inner surface of the hydrophobic membrane.

20. The aerator system of claim 19, wherein the one or more protrusions define a helical path between the outer surface of the solid rod and the inner surface of the hydrophobic membrane as the flow path.

21. The aerator system of claim 19, wherein the one or more protrusions comprise a plurality of separate protrusions spaced about the outer surface of the solid rod.

22. The aerator system of claim 15, wherein an outer surface of the flow portion where the gaseous fluid is configured to be released to the liquid fluid flow is configured to be perpendicular to the liquid fluid flow within the conduit.

23. The aerator system of claim 15, wherein aerator device is disposed concentrically within the conduit.

24. The aerator system of claim 15, wherein the conduit comprises:
a first portion that defines a portion of the liquid fluid flow within the conduit where the flow is unobstructed by the aerator device; and
a second portion that defines a portion of the liquid fluid flow within the conduit where the aerator device is disposed,
wherein the aerator device disposed in the second portion of the conduit causes the second portion to form a Venturi throat such that the liquid fluid flow is constricted in the second portion relative to the first portion such that the liquid fluid flow has increased velocity and decreased pressure in the second portion of the conduit.

25. A method of aerating a fluid, the method comprising:
placing the aerator device of claim 1 into the liquid fluid flow of a conduit defining a fluid flow path for a liquid fluid flow; and
providing the gaseous fluid through the flow path defined by the aerator device and through the hydrophobic membrane into the liquid fluid flow.

26. The method of claim 25, wherein the fluid is at least one of argon, air, oxygen, ozone, CO₂, and combinations thereof.
